(19) United States
(12) Patent Application Publication
(10) Pub. No.: US 2008/0157745 A1
(43) Pub. Date: Jul. 3, 2008

(54) Circuit system, circuit unit, power supply unit, and power supply method

(75) Inventor: Nobuki Nakata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/984,537

(22) Filed: Nov. 19, 2007

(30) Foreign Application Priority Data
Dec. 28, 2006 (JP) 2006-355709

(51) Int. Cl. G05F 3/00

(52) U.S. Cl. 323/304

(57) ABSTRACT

A circuit system comprising a power supply unit configured by a POL power source and a circuit unit of a low voltage/large current consumption for receiving supply of power from this power supply unit and able to respond to a sudden change of load of the circuit unit at a high speed, whereupon the circuit unit is provided with an increase prediction function unit for predicting in advance an increase of its internal power consumption and wherein when an increase is predicted in the function unit, increase prediction information is given to a power supply control function unit before an output voltage of a power supply unit starts to drop so that a power supply capability of the power supply unit is increased in advance.

### BACKGROUND OF THE INVENTION

1. Field of the Invention

The present invention relates to a circuit system, more particularly a circuit system comprised of a circuit unit and a power supply unit for supplying power in response to a sudden change of load of the circuit unit at a high speed.

2. Description of the Related Art

In communication apparatuses, server systems, high performance personal computers, and other IT (information technology) apparatuses, in accordance with the improvement of their functions and performances, both reduction in the voltage and increase of the current are desired in the hardware configuring these apparatuses, particularly the FPGAs (field programmable gate arrays), L2/L3 (Layer2/Layer3) switches, CPUs, DSPs, and other circuit units (devices). For this reason, in the power supply units for driving these hardware as well, higher performance such as higher efficiency, higher precision, and higher speed response are being demanded. Therefore, power supply units based on decentralized power supply systems such as POL (Point-of-Load) systems have been proposed and are starting to be employed.

Note that as an example of known art related to the present invention, there is the following Japanese Patent Publication (A) No. 2000-99166. A power source control device disclosed in this Japanese Patent Publication (A) No. 2000-99166 is characterized by automation of adjustment of the output of the power source unit by configuring the device to supply a reference voltage from the power source control unit in the system to the power source unit, measure the voltage of a predetermined portion of the system, and control this reference voltage so as to enable control of an output voltage of the power source unit.

To improve the fast response performance described above for power supply units of the above POL and other decentralized power supply systems, R&D is proceeding on systems which are excellent in high speed response, such as the ripple converter system and multi-phase shift system.

However, even now, the trend toward voltage reduction/current increase in circuit units (devices) is continuing. The demands on performance of decentralized power supply systems using POL, particularly the demands on high speed response performance, are becoming increasingly severe.

### SUMMARY OF THE INVENTION

Accordingly, in consideration of further voltage reduction/current increase in circuit units (devices) in the future, an object of the present invention is to provide a circuit system provided with a circuit unit and a power supply unit able to realize further improvement of the high speed response performance. In this case, the present invention realizes the high speed response performance by a completely different viewpoint from that of the known art such as the ripple converter system and multiphase shift system described above.

To attain the above object, the present invention provides a circuit system, comprising a power supply unit configured by a POL power source and a circuit unit of a low voltage/large current consumption for receiving supply of power from this power supply unit and able to respond to a sudden change of load of the circuit unit at a high speed. For this purpose, a circuit unit (3) is provided with an increase prediction function unit (5) for predicting in advance an increase of its internal power consumption. When an increase is predicted in the function unit (5), increase prediction information (Ipr) thereof is given to a power supply control function unit (6) before an output voltage of a power supply unit (2) starts to drop so that a power supply capability of the power supply unit is increased in advance.

### BRIEF DESCRIPTION OF THE DRAWINGS

The above object and features of the present invention will be more apparent from the following description of the preferred embodiments given with reference to the accompanying drawings, wherein:

FIG. 1 is a diagram showing the basic configuration of a circuit system according to the present invention,

FIG. 2 is a diagram showing the configuration of an L2 switch device,

FIG. 3 is a diagram showing the configuration of an L2 frame handled by the L2 switch device of FIG. 2,

FIG. 4 is a first part of a diagram showing an example of the configuration of a circuit unit according to the present invention,

FIG. 5 is a second part of a diagram showing an example of the configuration of the circuit unit according to the present invention,

FIG. 6 is a diagram showing a concrete example of a load prediction unit shown in FIG. 4 and its related portions,

FIG. 7 is a diagram showing an example of the configuration of a power supply unit according to the present invention,

FIG. 8 shows waveform diagrams depicting examples of characteristic features of the circuit unit and power supply unit according to the present invention,

FIG. 9 is a flow chart showing a power supply method according to the present invention,

FIG. 10 is a flow chart showing an example of applying the power supply method of the present invention to another circuit system,

FIG. 11 is a diagram showing an example of a conventional general power supply unit, and

FIG. 12 shows waveform diagrams depicting examples of characteristic features of the circuit unit and the power supply unit of FIG. 11.

### DESCRIPTION OF THE PREFERRED EMBODIMENTS

Preferred embodiments of the present invention will be described in detail below while referring to the attached figures.

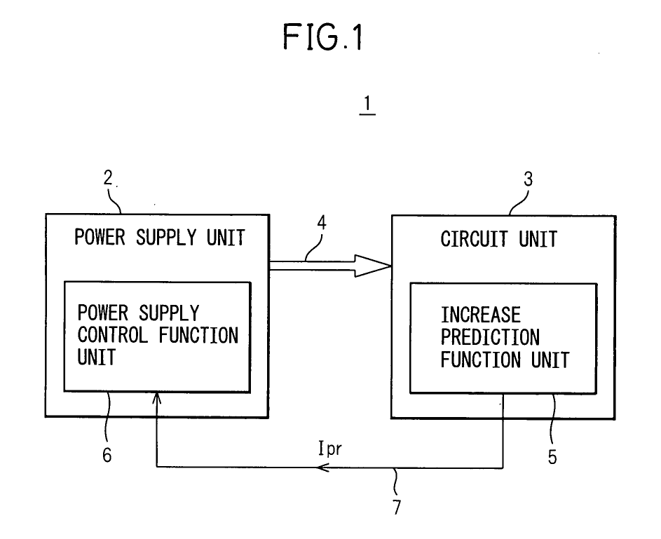

FIG. 1 is a diagram showing the basic configuration of a circuit system according to the present invention. In the figure, reference numeral 1 indicates a circuit system according to the present invention. This has a circuit unit 3 receiving as its input the supply of power and performing a circuit operation and a power supply unit 2 for supplying power to the circuit unit 3 via a power supply line 4.

Here, when the circuit unit 3 predicts an increase of the power consumption after a certain timing, the power supply unit 2 performs as its basic operation an increase of the power supply capability thereof in advance preceding that timing.

As a concrete example for executing such a basic operation, FIG. 1 shows an increase prediction function unit 5 and a power supply control function unit 6. Namely, the circuit unit 3 is provided with the increase prediction function unit 5 able to predict the increase of the power consumption in this circuit unit before the above-described timing and transmits increase prediction information Ipr (prediction) at the time of that prediction. On the other hand, the power supply unit 2 is provided with a power supply control function unit 6 for receiving the above increase prediction information Ipr transmitted when the circuit unit 3 predicts the increase of the power consumption before the above-described timing via an instruction line 7 and increasing the power supply capability.

Thus, a drop of the output voltage of the power supply unit 2 along with the increase of the power consumption in the circuit unit 3 is predicted in advance, and power can be supplied without allowing a drop of the output voltage.

When the circuit unit is for example an L2 switch, an input of an L2 frame to the L2 switch is detected by for example a header portion (for example preamble) of the L2 frame. The function unit 5 predicts that a data portion (IP packet) having a large power consumption continues after that subsequently.

In general power supply units hithertofore, when the load of the circuit unit abruptly increases due to arrival of the data portion consuming a large power described above, the drop of the output voltage of this power supply unit is detected by itself first, and the output current is increased by this detection. Namely, this is feedback control. In this case, usually, due to a discharge time of an exterior capacitor arranged very close to the circuit unit, the above output voltage cannot rapidly fall and there is a first delay time until the above detection. Then, after that detection, the above output voltage rises to the original voltage before the drop by the supply of charge current to the capacitor. At this time, however, due to a choke coil (explained later) etc., the output voltage cannot rapidly rise to its original voltage, and there is a second delay time until the output voltage returns to its original voltage.

In the end, the output voltage cannot return to the original output voltage in a time shorter than the sum of the first and second delay times. Therefore, there is a limit to the fast response performance in a conventional general power supply unit.

The present invention enables a great reduction of the first and second delay times from the drop of the output voltage of the power supply unit described above to the return of the output voltage to the original output voltage, caused by a sudden increase of the load in the circuit unit. Here, an improvement of the high speed response performance of the power supply unit can be achieved.

In order to clarify the effects brought about according to the present invention, first of all, an explanation will be given of a conventional power supply unit.

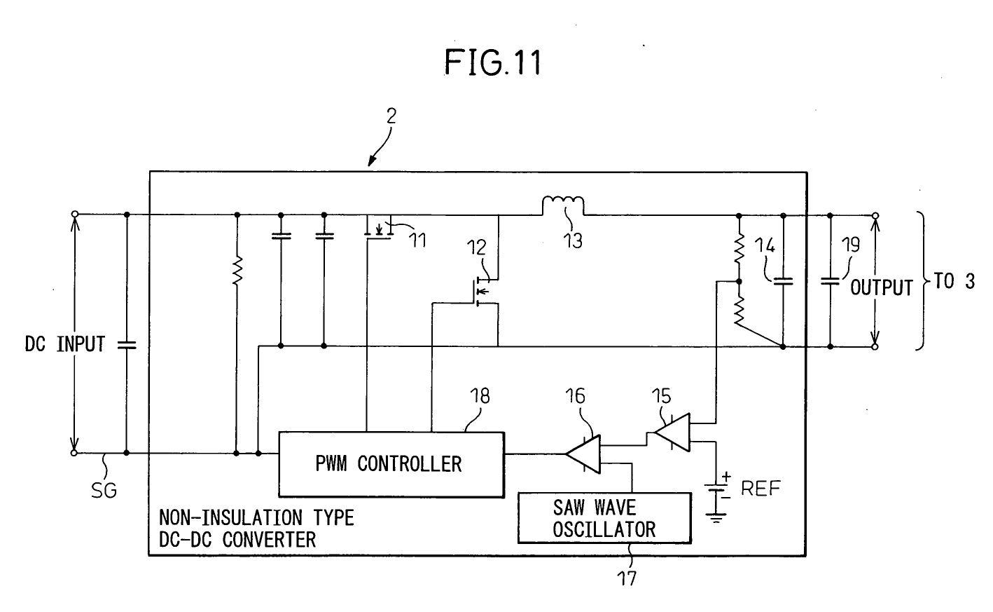

FIG. 11 shows an example of a conventional general power supply unit 2 and shows a power supply unit 2 comprising a non-insulation type DC-DC converter used for POL.

In this configuration of the POL, this power supply unit 2 is arranged very close to the circuit unit (device) 3 consuming the low voltage/large current. By supplying from the position very near the circuit unit 3, an occurrence of voltage drop and noise due to a resistance value and an inductance value of the power supply line pattern is greatly suppressed. Further, in the fast response type POL, a phase delay in a feedback loop of an output voltage fluctuation is kept down to the minimum.

The output voltage ripple, the basic characteristic feature, of the DC-DC converter (2) shown in FIG. 11 occurs due to charging an output capacitor 14 based on alternate on/off operations (switching control) of the switching transistors (FET) 11 and 12 in linkage with the choke coil 13 and discharging the output capacitor 14 due to the power consumption in the circuit unit 3.

In a PWM (pulse width modulation) control shown in the figure, the fluctuation of the output voltage described above is monitored by an error amplifier 15 and the monitored fluctuation is fed back to the PWM controller 18 to change an on/off duty ratio of the above switching control. The output voltage thereof is controlled by this.

Below, an example of the problem to be solved in the present invention will be explained. Here, as the related art, a POL having an average response speed (about 10 μs) is taken as an example, and the problem thereof is explained. In this case, that response speed (i.e., the time after detecting the drop of the output voltage to when feedback is activated and the output voltage returns to the original output voltage before the drop, that is, the first and second delay times explained before) is 10 μs, therefore a delay time until that feedback is activated is thought to be about 3 μs at the fastest. This will be explained with reference to the drawing.

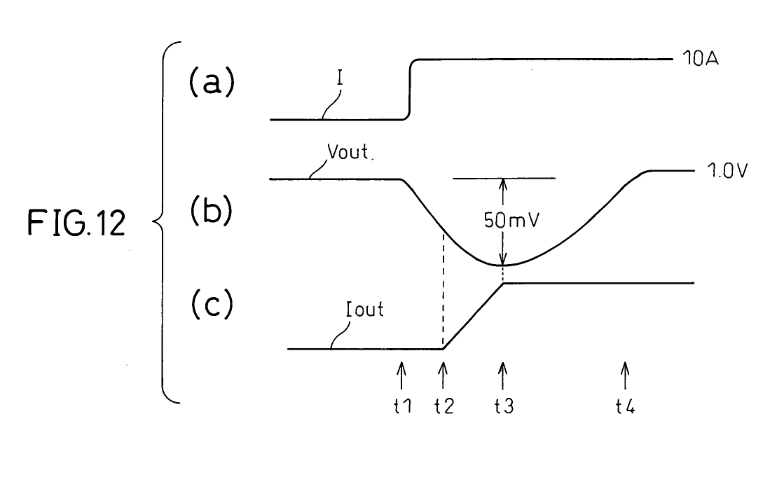

FIG. 12 shows waveforms of a load current (a) of the circuit unit 3 and an output voltage (b) and an output current (c) of the power supply unit 2.

In the figure, assume that a load current I of the circuit unit 3 suddenly changes (load fluctuates) to 10 A at a time t1. Then, an output voltage Vout of the power supply unit 2 begins to drop, but does not rapidly drop due to the existence of the output capacitor 14 and the exterior capacitor 19, but gradually drops. Then, when the output voltage reaches a predetermined threshold (REF) at a time t2, feedback control for raising that falling output voltage Vout begins to be carried out by the error amplifier 15, PWM comparator 16, and PWM controller 18 of FIG. 11.

By the start of this feedback control, an output voltage Iout increases, the drop of the output voltage Vout is reduced after the time t2, then that drop stops at a time t3. After that, Vout changes to rise and returns to the original output voltage Vout after a time t4.

The above time “10 μs” for returning to the original output voltage Vout corresponds to t1→t4 in FIG. 12, and the delay time “3 μs” until the feedback is activated corresponds to t1→t2. Note that usually the drop of the output voltage Vout is prescribed within for example 50 mV in the POL. Therefore, not only a short return time to the original output voltage, but also a small fluctuation width of the output voltage are demanded.

The above operation will be explained below by using concrete numerical values.

Assume that the load of the circuit unit 3 abruptly fluctuates (current pulled in) at a certain time t1. Further, assume that the output voltage of the DC-DC converter is 1.0V, the sum of the capacities of the capacitors 14 and 19 is 100 μF, a fluctuation of the output current Iout is 10 A, and a current fluctuation rate thereof is 20 A/μs. The drop of the output voltage Vout after 3 μs is calculated under these conditions.

Under these conditions, the current I monotonously increases until 0≦t≦500 ns (t2→t3) and becomes constant (10 A) when 500 ns≦t(t3).

The voltage fluctuation when 0≦t≦500 ns becomes

ΔV(500 ns)=25 mV

since

ΔV(t)=1/C*∫i(t)dt=1/C*∫atdt (a: 10 A/500 ns current changing ratio)

The voltage fluctuation when 500 ns≦t becomes

ΔV(3 μs)=25 mV+250 mV=275 mV

since

ΔV=1/C*i*(t−500 ns)

This is about 28% of 1.0V. Usually, a voltage range permitted for a device operating at 1.0V is about ±5% (50 mV). Therefore, this POL cannot be used as a power source for driving a device.

Further, it must be remembered that a noise component other than this (noise etc. occurring due to the line patterns) is added in actuality.

In practice, there are already demands for fast response that exceeds the changing ratio 20 A/μs when the fluctuation current ΔI≧10 A. Dealing with this by the performance of the POL explained above is, in the end, impossible.

In order to meet such demands, a fast response type POL employing a ripple converter system etc. has appeared. Note that the performance of ripple converter type POL will be explained later.

The present POL converters, including the fast response ripple converters, are configured so that when the output current Iout fluctuates, the fluctuation of the output voltage Vout occurring as a result of that is fed back, therefore occurrence of delay of the response is unavoidable.

The present invention takes note of this point and proposes a new response control system shown in FIG. 1. Namely, the present system realizes an ultra-high speed response performance by predicting a timing of load fluctuation and adding this as a control parameter to the feedback control. The innovativeness of the present invention resides in that a function for predicting the data to be processed from now is provided in the circuit unit 3 which consumes the electric current and the prediction result is added as a POL control parameter. That is, the circuit unit 3 and power supply unit (POL) 2 are handled as a chip set, and the power supply control is carried out by the linkage between those.

In the present invention, an explanation will be given mainly by a concrete example for a communications apparatus. In the field of communications apparatuses, the rapid spread of the Internet/intranets etc. in recent years has promoted the achievement of higher functions and higher performances (larger capacity and higher speed) of switches and other devices. Along with this, the voltage reduction/current increase of the circuit units (devices) configuring the apparatuses is needed. In this case, the above basic idea of predicting sudden changes of load and adding this prediction to the control parameters is extremely effective. Note that this basic idea can be applied to other fields such as servers and high performance personal computers as well. An example of application where this is applied to a personal computer will be explained later.

In the above explanation, a POL having an average response speed (about 10 μs) was explained as the related art. However, as further related art, a ripple converter type POL of probably the highest response performance at the present time will be studied.

This ripple converter system is a system providing thresholds (Vthh, Vthl) on the high side/low side of the reference voltage, turning on an FET (corresponding to the FET 11 of FIG. 11) supplied with power from the input side when the output voltage becomes lower than that low side threshold, and turning off that FET when the output voltage exceeds that high side threshold. Due to this, power can be supplied to the fullest simultaneously with the detection of the output voltage being the low side threshold or less, therefore high speed response becomes possible.

The ripple converter type fast POL at the present time responds with a load fluctuation of 2% (20 mV) under the same conditions as the already explained conditions, that is, an output current fluctuation: 10 A, fluctuation rate: 20 A/μs, and sum of output side capacitors: 100 μF. With this performance, the POL can handle sudden changes of the load with no problem. When calculating the feedback delay time of the POL in this case, it becomes about 150 ns.

Assume here that the current changing ratio and current changing width become two times the load fluctuation. The current changing rate in this case becomes 80 A/μs. Further, the change of the output current is 10 A. In this case, a voltage fluctuation ΔV occurring until the feedback is activated is calculated by:

0≦t≦250 ns: ΔV=1/C*∫idt

(where i=at: a is a current changing ratio per unit time)

250 ns≦t: ΔV=1/C*i*t (i=20 A),

and the value of that ΔV becomes about 38 mV. (Note, calculated assuming that low side threshold Vthl is 10 mV).

However, noise due to the inductance value of the line patterns caused by the above current change and noise due to the line pattern resistance are added in an amount of several tens mV, therefore even the ripple converter system can no longer handle such a voltage fluctuation ΔV.

Here, a concrete embodiment of a circuit system 1 according to the present invention shown in FIG. 1 will be explained.

As a load fluctuation level, the current (I) fluctuation rate: 80 A/μs, output current fluctuation: 20 A, and output voltage: 1.0V shown in the previous example are applied. Also, the total capacity of the output capacitor 14 and exterior capacitor 19 is made 100 μF in the same way as the above.

Further, as the circuit unit 3 in the circuit system 1 of FIG. 1, an explanation will be given taking as an example a large capacity L2 switch device which is now rapidly advanced in voltage reduction and current increase characteristics due to the spread of the Internet/intranet in recent years.

In the field of L2 switches, devices having an exchange capability exceeding 200 Gbps already have begun to appear. At present, a switch device inside an apparatus is divided into several devices for switching and divided into capacities of about 50 Gbps each. Already, demands for making the current fluctuation rate 20 A/μs and the output current fluctuation 10 A or more have appeared. It can be easily imagined that, in the near future, the higher functions and higher performances will lead to higher degrees of integration of these devices and thus one or two or so of the devices will be able to perform exchange processing of about 200 Gbps. The demands on the high speed response with respect to load fluctuations in this case will become further severer.

For this reason, here, an L2 switch device accommodating GbE (Gigabit Ethernet®) 100 channels, having an exchange capability of 100 Gbps, and requiring a current fluctuation rate of 80 A/μs and an output current fluctuation of 20 A at the time of fast load fluctuation, is used as an example of the circuit unit 12. Note that, in the embodiment, an LSI chip etc. for realizing an L2 switch function will be represented as an L2 switch device and will be referred to as an L2 switch apparatus as a whole. An example in a case of applying the load fluctuation prediction of the present invention to this L2 switch device will be explained.

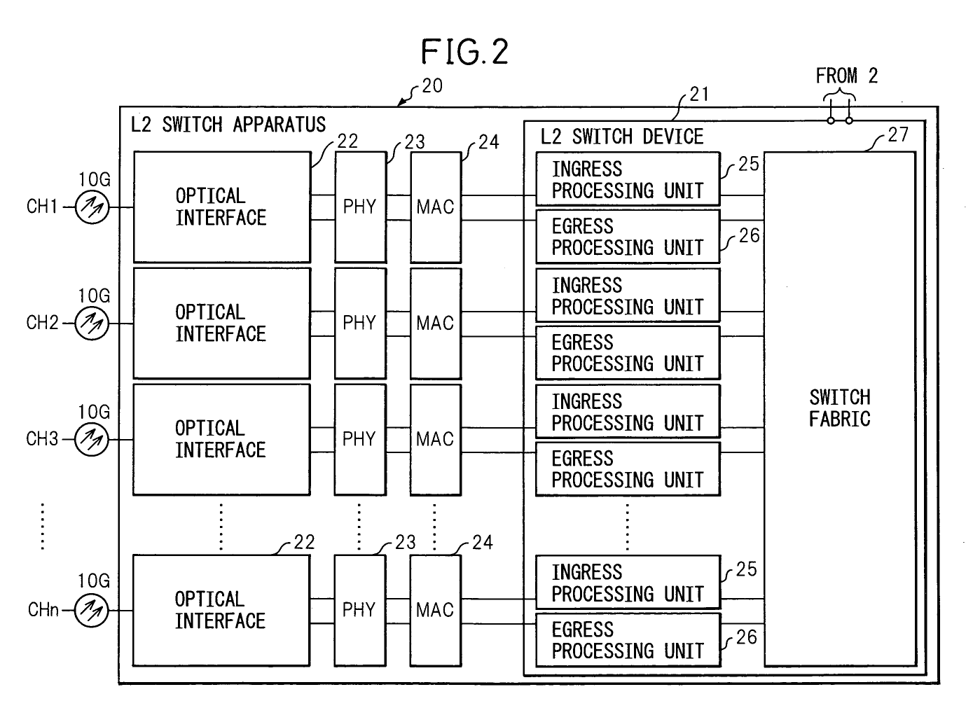

FIG. 2 is a diagram showing the configuration of an L2 switch apparatus 20. An L2 switch device 21 is included in that. The present invention is realized in this L2 switch device 21. In the figure, the inside of the L2 switch apparatus 20 is configured by a plurality of channels CH1 and CH2 to CHn. All channels have the same configuration. Namely, each is configured by an optical interface 22 having an optical transmission module, a PHY unit 23 for performing processing on a physical layer, a MAC unit 24 for performing processing on a data link layer, and further an ingress processing unit 25 and an egress processing unit 26 in the L2 switch device 21 and is connected to a switch fabric 27.

The ingress (input) processing unit 25 registers an address of a MAC frame in a forwarding database (FDB), judges relay, and so on, while the egress (output) processing unit 26 transfers a MAC frame to a transmitting port in accordance with a degree of priority etc. The switch fabric 27 performs the exchange of MAC frames from the ingress processing unit 25 to the egress processing unit 26 by hardware. Note that, 28 is a power source input unit supplied with the power from the power supply unit 2.

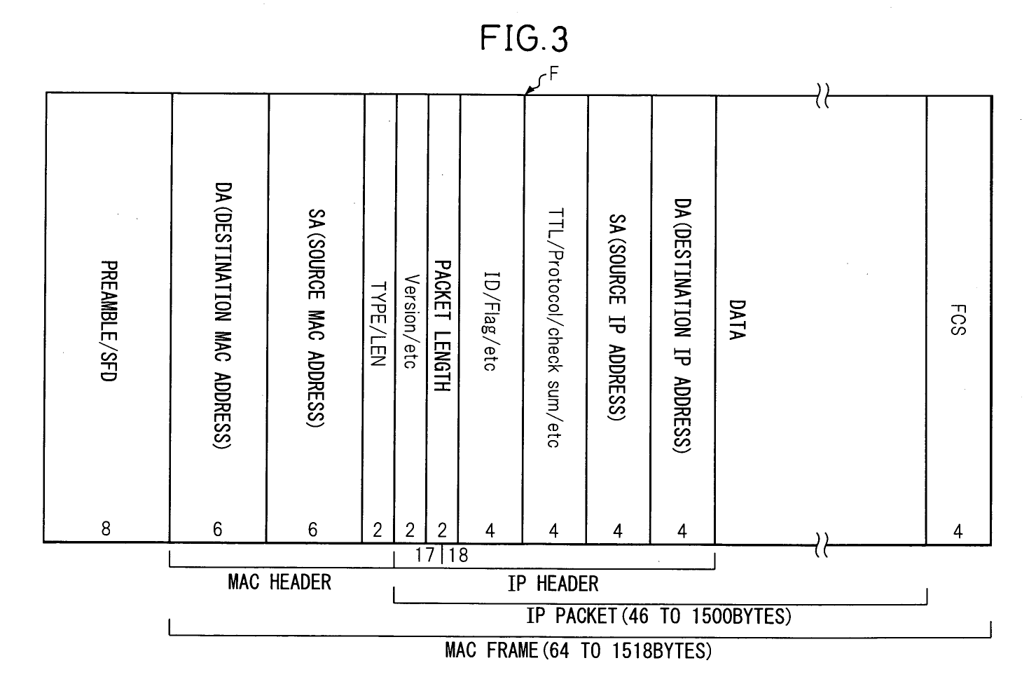

FIG. 3 is a diagram showing the configuration of an L2 frame. The L2 switch apparatus 20 of FIG. 2 handles this L2 frame F. Note that the numerals of 8, 6, . . . , etc. shown at the lower end in the L2 frame F represent byte numbers. Further, as L3 data included in this L2 frame F, use is made of the currently widely used IP protocol. Here, the prediction of the load fluctuation in the L2 switch device 1 and the operation on the POL (power supply unit 2) side become as follows.

1) When a MAC frame is input to the L2 switch device 2 from its header, the L2 switch device 21 first detects the SFD (start frame delimiter). At this time, an amount of data of at least 64 bytes is guaranteed. This is because the minimum length of the MAC frame is 64 bytes.

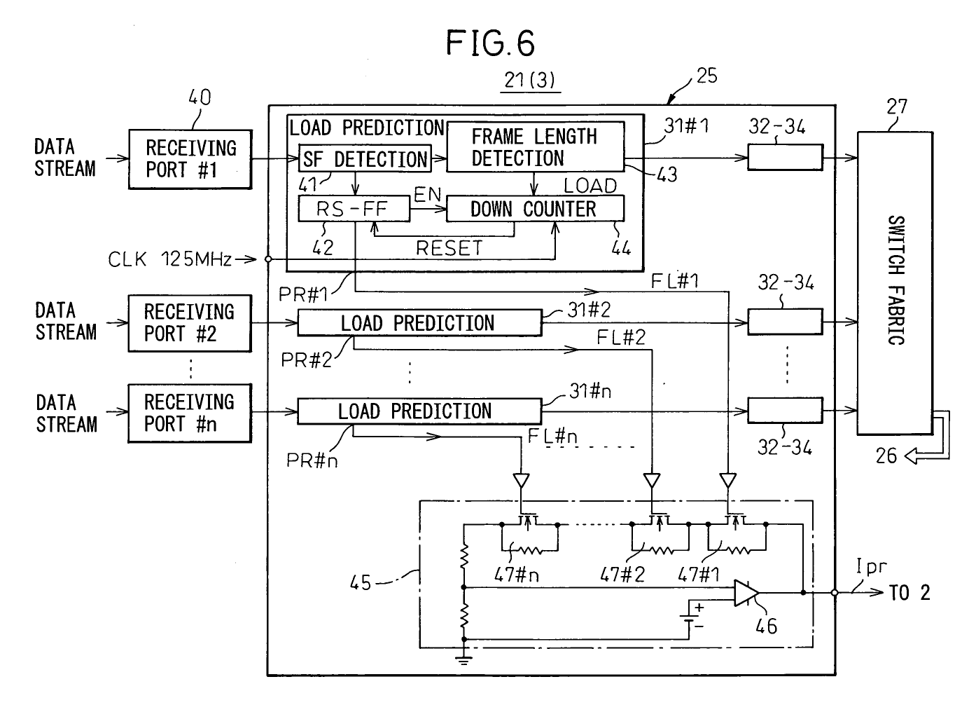

2) In a channel CH which detects that SFD, a flag indicating that the data is input (data input flag: see FL of FIG. 6) is set (made ON). This data input flag indicates that data processing is occurring in the related channel CH. Note that, at this time, most of the data does not yet enter into the L2 switch device 21, therefore almost no power consumption occurs.

3) When the data input proceeds and the 17th and 18th bytes from the header of the MAC frame are input, this data is set in a counter (see 44 of FIG. 6). This counter indicates the amount of data (data length) to be processed in the channel CH then. These 17th and 18th bytes represent the length of the overall IP datagram including the IP header by a numerical value in units of bytes. At this time, the length obtained by subtracting the already input header's worth of 4 bytes becomes the length of the remaining IP datagram, but the 4 bytes of a FCS (frame check sequence) are attached to the end of the MAC frame, therefore the IP datagram length read at this time becomes the data length up to the MAC frame end as it is.

4) The above counter is decremented. The unit is GbE in the present embodiment, and the set value is represented by units of bytes, therefore a clock for performing the decrement becomes 125 MHz (1 G÷8).

5) At the time when the above counter becomes zero, the above data input flag for the related channel CH is cleared. Namely, the end of the data processing (period for consuming the power) in the related channel, more precisely speaking the ingress processing unit 25, is indicated.

6) The same processing is carried out in each channel CH, then a control signal corresponding to the total number of the above data input flags in the ON state is sent to the POL (power supply unit 2). This control signal is the increase prediction information Ipr of FIG. 1 and shows the amount of data processing of the overall L2 switch device 21. Further, the data input flag is asserted for a period including the amount of data (data length) to be processed from now, therefore a period for which power is consumed in the related channel CH is predicted.

7) The POL (power supply unit 2) side performs the detection and monitoring by the low side/high side threshold (Vthl/Vthh) of the ripple converter system and simultaneously performs the PWM control according to the control signal (Ipr) received from the L2 switch device 21 for a period during which the output voltage Vout is the low side threshold Vthl or more and the input side FET (11) of the ripple converter is OFF. Namely, if the control signal (Ipr) input from the L2 switch device 21 shows a state where the amount of data which must be processed in the L2 switch apparatus 20 is large, the drop of the output voltage Vout is suppressed by making the period during which the power supply in the PWM control is ON (period during which the input side FET (11) is ON) longer. Further, when the detected voltage does not reach the low side or high side threshold (Vthl, Vthh) of the ripple converter system, the inherent operation of the ripple converter system is carried out.

Here, the fluctuation of the load (power consumption) in the L2 switch device 21 may be as follows.

The power consumption increases in the L2 switch device 21 mainly in a case where the amount of data to be processed is large. Further, a sudden change of the load occurs at the time of an abrupt shift from a state of a small amount of data to be processed to a large amount. In such a case, so far as the data is input at a small number of channels (several channels), this can be sufficiently covered by the power supply from the exterior capacitor 19 mounted very close to a power source terminal (28) of the L2 device. Further, even in the case of a large number of channels, so far as the amount of the data is small (several frames) and the time is short, this can be covered by the power supply from the exterior capacitor 19 as well. In practice, short frames and large amounts data never continuously flow. This is because, with short frames, the ratio of the header portion in the frame becomes relatively large, and the transmission efficiency is much degraded.

Such a large sudden load change (current fluctuation rate: 80 A/μs, output current fluctuation: 20 A) handled in the present embodiment and the voltage drop due to that occur in a case where a large number of channels shift from a light load state to a heavy load state in a short time. The power supply according to the present invention can cover the fluctuation of the data amount in a case of only a small number of channels and data fluctuation due to short frames. However, the effects of the present invention remarkably appear in a case where a large sudden load change as previously explained occurs.

In the case where a large amount of data input causing a large sudden change of load occurs, the length of 1 frame (F) is near the maximum length. This is because, as explained before, the transmission efficiency is greatly degraded with short frames. Note that the length of a MAC frame is 64 bytes at the smallest to 1518 bytes at the largest (according to the standards of the IEEE 802.3).

The principle of the load fluctuation prediction explained above is to detect the input of a MAC frame first according to SFD detection, then predict the length of the data to be processed according to the information of the packet length included in the IP header. At this time, most of the MAC frame has not yet entered into the L2 switch device 21, therefore almost no increase of the power consumption has occurred. The time when this power consumption becomes large is the time when most of the data of the MAC frame enters into the L2 switch device 21 and these data are switched in that. Namely, since the L2 switch device 21 employs a store and forward system, therefore, this is the time at the writing of the data into internal queues. Accordingly, when assuming that the frame length of the MAC frame is 1000 bytes, at the time when first about 10% of data is input, the power consumption has not yet increased so much. This data length of about 10% is 100 bytes, that is, 800 bits, and corresponds to a time of 800 ns in GbE. At the above time of SFD detection, by notifying that the data processing is started in the related channel to the POL (power supply unit 2) side by using the above data input flag, it becomes possible to increase in advance the supplied power of the POL (power supply unit 2) 800 ns before the start of the fluctuation of the output voltage Vout at the latest. Then, since the feedback delay time of the aforesaid fast response ripple converter type is about 150 ns, preparations for coping with the voltage fluctuation can be started even about 800 ns before the start of fluctuation of the output voltage Vout by using this prediction control system.

Next, a detailed example for realizing the present invention will be explained.

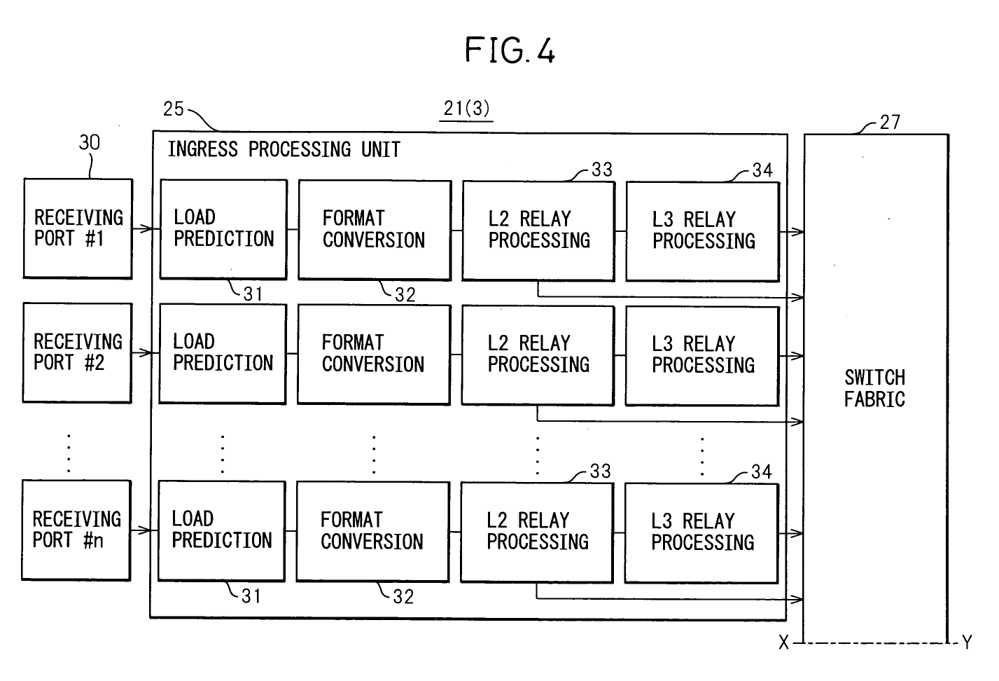

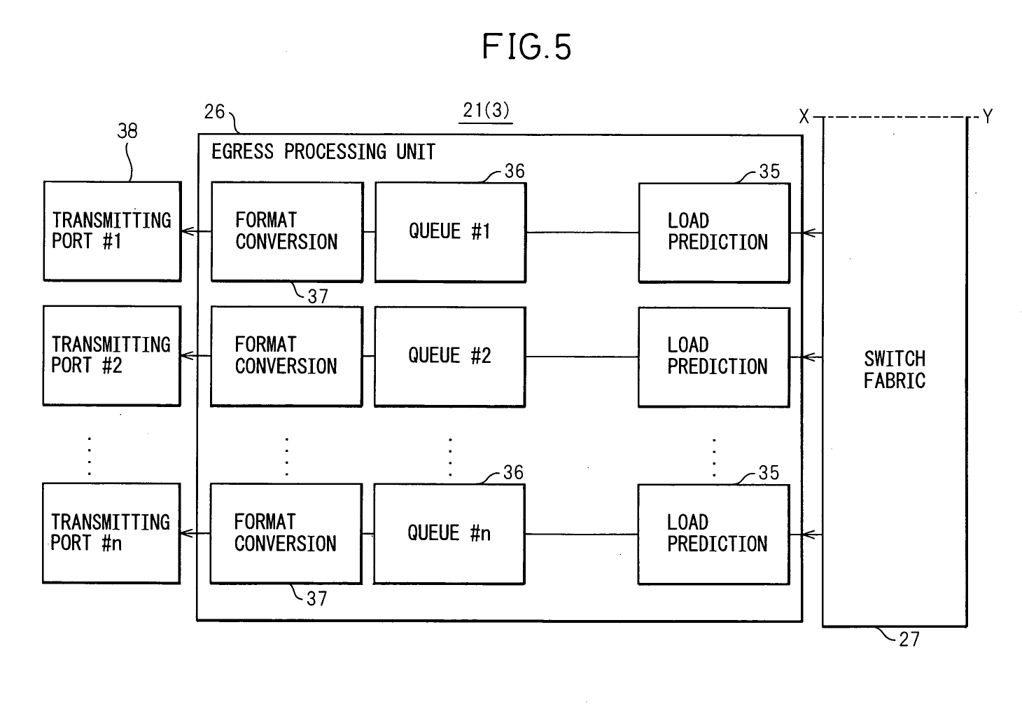

FIG. 4 is a first part of a diagram showing an example of the configuration of the circuit unit 3 according to the present invention, and FIG. 5 is the second part. The circuit unit shown in the two diagrams is shown with reference to the example of the L2 switch device 21 of FIG. 2.

FIG. 4 shows only the ingress processing units 25 in FIG. 2 collectively for each channel, and FIG. 5 shows only the egress processing units 26 in FIG. 2 collectively for each channel. An input data stream from any of the receiving ports (#1, #2, . . . , #n) provided to the corresponding channel is first input to the load prediction unit 31 according to the present invention, whereupon detection for predicting any sudden change of load is carried out. Further, the already exchanged data from the switch fabric 27 which must be output to corresponding one of the transmitting ports (#1, #2, . . . , #n) provided to the corresponding channel of FIG. 5 is first input to the load prediction unit 35 according to the present invention, whereupon any sudden change of the load is predicted. Note that, the switch fabric 27 is mainly configured by a memory in the case of the “store and forwarding type”.

When there is a sudden change of the load, the ingress unit 26 of FIG. 4 performs the detection for the prediction thereof, then converts this to a data format suitable for the processing in an L2 relaying unit 33 at the next stage at a format converting unit 32, performs the processing at the L2 relaying unit 33, inputs the data to the switch fabric 27, performs the processing at an L3 relaying unit 34, then inputs the data to the switch fabric 27.

On the other hand, when there is a sudden change of load, the egress unit 26 of FIG. 5 performs the detection for the prediction thereof, outputs the transmission data group in a predetermined sequence by a queue unit 36, reconverts this to the L2 frame format of FIG. 3 at a format converting unit 37, then transmits this as an output data stream to the network from the L2 switch apparatus 20.

FIG. 6 is a diagram showing a concrete example of a load prediction unit 31 shown in FIG. 4 and its related portions. Note that the configurations of the load prediction unit 35 in the egress processing unit 26 shown in FIG. 5 and its related portions are exactly the same, therefore only a concrete example in the ingress processing unit 25 is shown in FIG. 6.

Further, all of load prediction units 31#1, #2, . . . , #n connected to the receiving ports #1, #2, . . . , #n have the same configuration, therefore only a load prediction unit 31#1 will be shown in detail. This load prediction unit 31#1 is provided with an SFD detection unit 41, RS-FF (reset set-flip flop) 42, frame length detection unit 43, and down counter 44. Note that, after the frame length detection unit 43, the format converting unit 32 and L3 relaying unit 34 shown in FIG. 4 follow and the switch fabric 27 is reached.

Prediction outputs PR#1, #2, . . . , PR#n output from the above load prediction units 31#1, #2, . . . , #n are applied to a prediction outputting amplifier 45 as its gain control input all together. Here, the output of the prediction outputting amplifier 45 becomes the increase prediction information Ipr shown in FIG. 1 and output to the power supply unit 2.

When further concretely explaining the configuration of FIG. 6, the SFD (see FIG. 3) of the data stream (GbE signal) input from the above receiving ports #1, #2, . . . , #n is detected at the SFD detection unit 41, and the RS-FF42 is set according to this detection. The output of this RS-FF42 becomes the above prediction output PR#1 in the related channel (CH1). Here, this is referred to as the data input flag FL. By establishment of this data input flag FL, in this circuit, an amplification ratio of the amplifier 45 for outputting the POL (power supply unit 2) control signal, that is, the aforesaid increase prediction information Ipr, increases by 1 channel's worth, the PWM control voltage on the POL side rises, ON (Ton) period of the FET (see 11 of FIG. 11) for performing the PWM control is increased by this, and the power supply capability of the POL is increased.

Next, the frame length detection unit 43 reads a packet length of the datagram (17th, 18th bytes from the left of FIG. 3), and this value (byte unit) is set in the down counter 44 as it is. This down counter 44 performs the count down with a clock of ⅛ of the transmission clock (clock of about 125 MHz because of GbE in this concrete example).

At the time when the count of the down counter 44 becomes zero, the RS-FF42 is reset, and the data input flag FL is cleared. This is the timing when the last data of the reception data stream (“data” of a right half of FIG. 3) passes through the frame length detection unit 43. At this time, most data of the related data stream has been already written in the above explained memory in the switch fabric 27, therefore the power consumption is already reduced concerning this data stream and becomes near zero.

By performing the above operation at the input/output portions of all channels (#1, #2, . . . , #n), power information in the overall L2 switch device 21 which becomes necessary at that time can be transferred in advance to the POL (power supply unit 2) side.

When explaining the above prediction outputting amplifier 45 in further detail, the amplifier 45 has a variable gain amplifier 46 at its center, and a parallel circuit 47 of a switch (FET) and a resistor is connected to a feedback loop thereof. This parallel circuit is connected in series as 47#1, 47#2, . . . , 47#n in correspondence with channels corresponding to n number of load prediction units 31#1, 31#2, . . . , 31#n. The parallel circuits 47 makes the gain of the variable gain amplifier 46 variable according to the presence/absence of the above data input flag FL (#1, #2, . . . , #n). For example, when the data input flag is set, the FET of the corresponding parallel circuit becomes OFF, the gain increases, and the output voltage (Ipr) of the amplifier 46 increases in the level by 1 stage's worth. On the other hand, when the established data input flag is lowered, the FET becomes ON, and the output voltage (Ipr) increased in level by 1 stage's worth returns to the original level.

The increase prediction information Ipr generated as explained above is output to the power supply unit 2, whereupon the desired fast load fluctuation prediction response is achieved.

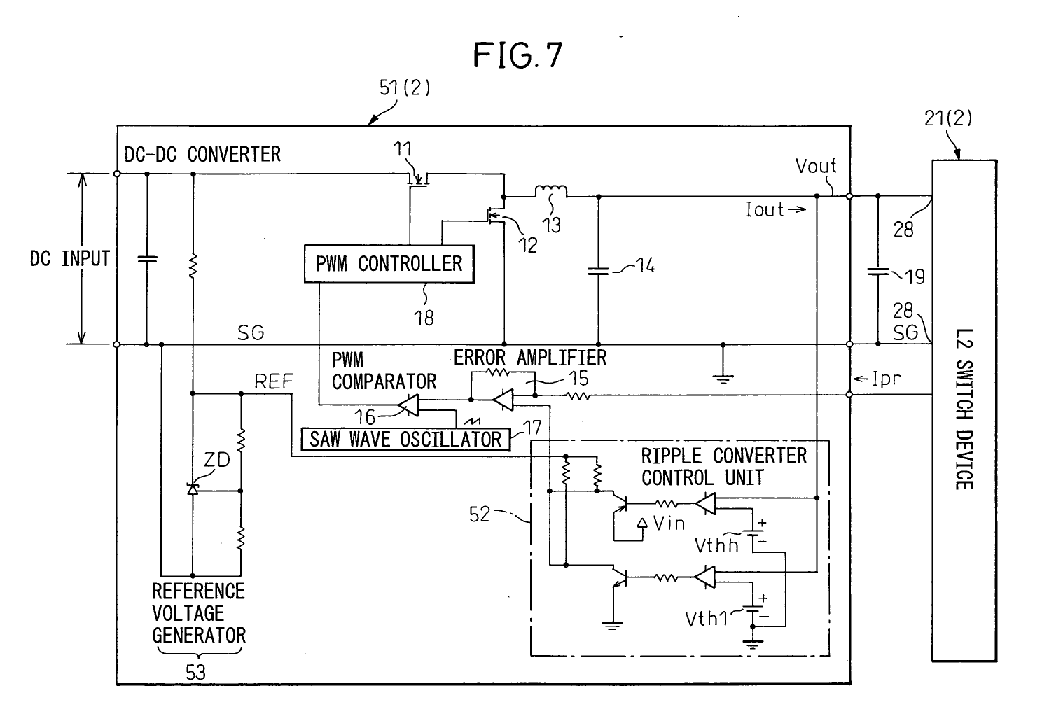

FIG. 7 is a diagram showing an example of the configuration of the power supply unit 2 according to the present invention. In the figure, the same reference numerals and reference symbols are shown for portions corresponding to the components of FIG. 11 explained before. Note, in contrast to FIG. 11 showing a non-insulation type DC-DC converter, FIG. 7 shows an example of a ripple converter type POL 51 considered to be the fastest at present as the power supply unit 2. A ripple converter control unit 52 in the figure is the characterizing feature of the ripple converter type POL 51. Note that, a portion for generating the reference voltage REF of FIG. 11 is shown as a reference voltage generator 53 as well. A zener diode ZD is included in that.

The portion which must be noted the most in FIG. 7 is the error amplifier 15. The output from the usual ripple converter control unit 52 is applied to an inverting input (−) thereof, while the aforesaid increase prediction information Ipr from the L2 switch device 21 (that is, the circuit unit 3) is applied as the POL control signal to a non-inverting input (+) thereof.

In this case, the ripple converter function (52) operates with a higher priority. That is, when the output voltage Vout becomes lower than the low side threshold Vthl of the ripple converter function, the PWM controller 18 turns the input side FET 110N. At this time, Vout becomes the maximum output. Further, when the Vout is between the low side and high side thresholds (Vthl/Vthh) of the ripple converter function, the PWM control is carried out according to the POL control input (Ipr). Further, when the Vout exceeds the high side threshold Vthh of the ripple converter function, the PWM controller 18 performs an operation for turning the input side FET 11 OFF in order to suppress an over voltage of the output Vout.

Here, the performance in a case where the above-explained fast load fluctuation prediction response system of the present invention is employed will be explained. The conditions in this case are a current fluctuation rate of 80 A/μs and an output current fluctuation of 20 A. The other conditions are an input voltage of 3.3V, output voltage of 1.0V, capacity C of the output side capacitor (14, 19) of 100 μF, inductor (13) L on the output side of the ripple converter type POL of 0.02 μH, high side threshold voltage Vthh as ripple converter of 110% of nominal voltage, and low side threshold Vthl of 90% of nominal voltage.

A sudden change of load occurs when the circuit unit 3 changes from a state where the data processing amount is small to a state where data streams are received for a large number of channels (CH) almost simultaneously and thus the amount of data processing abruptly increases.

As explained before, by employing the present invention, the power supply capability can be increased in advance about 800 ns before a sudden change of the load. The output voltage ΔV which can rise during this 800 ns becomes,

ΔV=1/C*∫idt

since

di=1/L*(Vin−Vo):dt,

(where Vin and Vo are an input voltage and output voltage of the inductor), and becomes:

ΔV=1/C*(Vin−Vo)/L*∫tdt=1/(100 μF)*(3.3−1.0)/0.02 μH*1/2*t²=14.72*10⁻³=368 mV.

Accordingly, the above ΔV sufficiently reaches the 10 mV of the upper limit of the high side threshold Vthh of the ripple converter function (52).

During the period after the sudden change of load described above starts and the input side FET in the ripple converter type POL51 is OFF, the power is also supplied in accordance with the power consumption, therefore the voltage drop ΔV is represented by the following equation:

ΔV=1/C*(Vin−Vo)/L∫tdt=1/C*I*t

(where I is the output current from the POL 51)

When calculating this, the fluctuation of the output voltage Vout after the start of a sudden change of the load becomes within ±10 mV (within ±1%) at any time t.

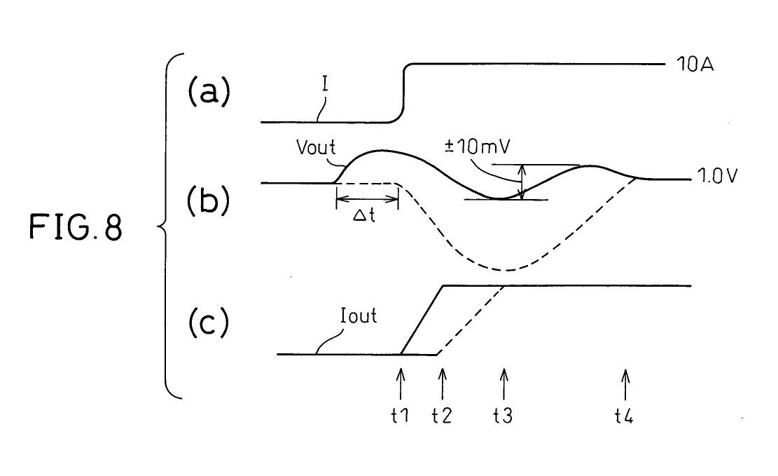

FIG. 8 shows waveform diagrams dericting examples of characteristic features of the circuit unit 3 and power supply unit 2 according to the present invention and correspond to the waveform diagrams of FIG. 12 explained before. Note that the waveforms shown in (b) and (c) of FIG. 12 are indicated by dotted lines in FIG. 8. The point which must be particularly noted in the figure is the output voltage Vout which rises in advance by exactly a time Δt relative to the time at the time of the rising of the load current I in (b) described above and converges to the original 1.0V in a short time after the time t1. The voltage fluctuation in the middle of this is within the 10 mV described above.

Summarizing the circuit system 1 of the present invention explained above, the circuit unit 3 is advantageously applied to a device consuming power by a low voltage and large current, while the power supply unit 2 is preferably a decentralized power supply type POL power source which can respond at a high speed to a rapid load fluctuation of the circuit unit 3.

As an example, when the circuit unit 3 is the L2 switch device 21, the increase prediction function unit 5 (FIG. 1) generates the increase prediction information Ipr when detecting that the header portion of the input L2 frame enters into the L2 switch device 21. In this case, when the increase prediction function unit 5 includes the variable gain amplifier 46, the gain is increased and then the increase prediction information Ipr is generated. Further, the increase prediction function unit 5 sets a time of generation of the increase prediction information Ipr based on information for displaying the IP packet length in the L2 frame (FIG. 3).

Note that, preferably the above POL power source is a POL power source based on the ripple converter system and gives higher priority to the level of increase according to the ripple converter control compared with the level of the increase indicated by the increase prediction information Ipr indicating the increase of the power supply capability.

Further, the idea of the present invention explained above can be grasped as a method of power supply in the circuit system 1 having the circuit unit 3 for performing the circuit operation by receiving the supply of power and the power supply unit 2 for supplying the power of the circuit unit 3.

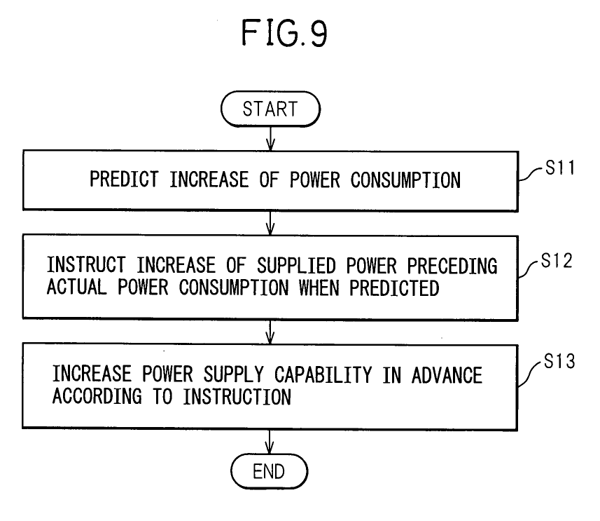

FIG. 9 is a flow chart showing the power supply method according to the present invention.

Step S11: In the circuit unit 3, it is judged whether or not an increase of the power consumption after a certain timing is predicted.

Step S12: When an increase of the power consumption is predicted at step S11, preceding that predicted timing, the increase prediction information Ipr of the supplied power is output to the circuit unit 3.

Step S13: The increase prediction information Ipr output at step S12 is received at the power supply unit 2, whereupon the power supply capability is increased before the above timing.

Further, the present invention can be grasped as a power supply program for executing the above power supply method (and a storage medium for storing this) as well. This power supply program is comprised by commands for making a computer execute (i) a first routine for judging whether or not an increase of the power consumption after a certain timing in the circuit unit 3 is predicted, (ii) a second routine of outputting increase prediction information Ipr of the supplied power to the circuit unit 3 preceding the predicted timing when an increase of the power consumption is predicted in this first routine, and (iii) a third routine of receiving the increase prediction information Ipr output in this second routine at the power supply unit 2 and increasing the power supply capability of before the above timing.

The above explanation was made for the example of the L2 switch apparatus 20 as the circuit unit 3, but the idea of linking the circuit unit 3 on the side consuming the power and the power supply unit (POL) 2 on the side supplying the power so as to supply the optimum power can be applied to other fields as well. For example, it can be applied to a CPU used in a personal computer (PC) etc. as well.

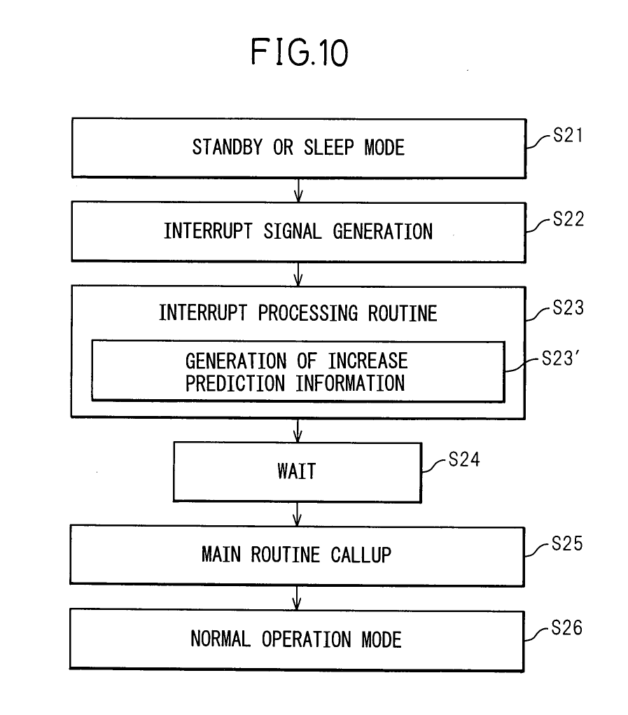

FIG. 10 is a flow chart showing an example of applying the power supply method of the present invention to another circuit system and shows an example of applying the present invention to the CPU described above. The gist of this power supply method resides in that, when the circuit unit 3 is a CPU, when the CPU in a standby mode or pause mode (sleep mode) shifts to the normal operation mode by an interrupt signal from the outside, the increase prediction function unit 5 generates the increase prediction information Ipr when detecting the generation of that interrupt signal.

Recent PCs are provided with a power management function for lowering the power consumption and shift the CPU to the standby mode or pause mode when the CPU is not operated for a certain time (step S21). After that, when the user performs some operation, the CPU is shifted from that standby/pause mode to the normal operation mode (step S26). At this time, a large sudden change of load occurs. According to the present invention, this sudden change of load can be coped with as follows.

The processing of shifting the CPU from the standby/pause mode to the operation mode is usually carried out by using an interruption. For this reason, when the hardware detects a user operation, an interrupt signal is generated (step S22). In this case, only an interruption acceptance function is not placed in the standby/pause mode.

When the CPU receives this interrupt signal, it calls up a corresponding interrupt processing routine (step S23). In this processing routine, processing for shifting the CPU to the normal operation mode, for example a transfer of cached data, setting of various types of registers, and release of the interruption mask are described.

Here, in this interrupt processing routine, a routine for generating the increase prediction information Ipr as the control signal to the power supply unit (POL) 2 is added (step S23′).

In this way, the POL control signal (Ipr) is generated, and the power supply output on the POL side is raised within the range of the rated voltage. The CPU side takes 1 μs, that is, a wait time of about 1 μs, for waiting for the rise of the POL from the transmission of the POL control signal (step S24), then shifts the CPU to the normal operation mode. At this time, the power supply output on the POL side has already risen. Therefore, in the same way as the previous example of the L2 switch device 21, a large drop of the output voltage due to a sudden change of load can be prevented.

While the invention has been described with reference to specific embodiments chosen for purpose of illustration, it should be apparent that numerous modifications could be made thereto by those skilled in the art without departing from the basic concept and scope of the invention.

What is claimed is:

1. A circuit system comprising a circuit unit for performing a circuit operation by receiving a supply of power and a power supply unit for supplying power to the circuit unit, wherein
when an increase of a power consumption in said circuit unit after a certain timing is predicted, said power supply unit is operative to increase in advance a power supply capability preceding that timing.

2. A circuit system as set forth in claim 1, wherein said circuit unit is provided with an increase prediction function unit able to predict an increase of said power consumption before said timing and transmits increase prediction information at the time of the prediction.

3. A circuit system as set forth in claim 1, wherein said power supply unit is provided with a power supply control function unit for receiving the increase prediction information transmitted when predicting the increase of said power consumption before said timing in said circuit unit and increasing said power supply capability.

4. A circuit system as set forth in claim 1, wherein said circuit unit is a device consuming power with a low voltage and a large current.

5. A circuit system as set forth in claim 1, wherein said power supply unit is a decentralized power supply type POL power source able to respond at a high speed to rapid load fluctuation of said circuit unit.

6. A circuit system as set forth in claim 2, wherein said circuit unit is an L2 switch device and said increase prediction function unit generates said increase prediction information when detecting that a header portion of an input L2 frame enters into the L2 switch device.

7. A circuit system as set forth in claim 6, wherein said increase prediction function unit includes a variable gain amplifier, increases the gain, and generates said increase prediction information.

8. A circuit system as set forth in claim 7, wherein said increase prediction function unit sets a generation time of said increase prediction information based on information displaying an IP packet length in said L2 frame.

9. A circuit system as set forth in claim 5, wherein said POL power source is a POL power source of a ripple converter system and imparts a higher priority to a level of increase according to the ripple converter control than the level of an increase indicated by the increase prediction information indicating the increase of said power supply capability.

10. A circuit system as set forth in claim 2, wherein said circuit unit is a CPU and when the CPU in a standby mode or sleep mode shifts to a normal operation mode by an interrupt signal from the outside, said increase prediction function unit generates said increase prediction information when detecting the generation of the interrupt signal.

11. A circuit unit for performing a circuit operation by receiving a supply of power from an external power source, provided with an increase prediction function unit for predicting that a power consumption in the circuit unit will increase after a certain timing and instructing in advance an increase of the power supply capability to the external power source preceding that predicted timing.

12. A circuit unit as set forth in claim 11, wherein said external power source is a decentralized power supply type POL power source able to respond at a high speed to rapid load fluctuation of said circuit unit, and said circuit unit applies the increase prediction information transmitted from said increase prediction function unit at the time of said prediction to the POL power source.

13. A power supply unit for supplying power to a circuit unit for performing a predetermined circuit operation, provided with a power supply control function unit for increasing a power supply capability when receiving increase prediction information, transmitted after prediction by said circuit unit, indicating an increase of the power consumption.

14. A power supply unit as set forth in claim 13, wherein said power supply unit is a decentralized power supply type POL power source able to respond at a high speed to rapid load fluctuation of said circuit unit.

15. A power supply method in a circuit system comprising a circuit unit for performing a circuit operation by receiving a supply of power and a power supply unit for supplying power to the circuit unit, comprising:
judging whether or not an increase of power consumption in said circuit unit after a certain timing is predicted;
outputting increase prediction information of the supplied power to said circuit unit preceding a predicted timing when an increase of the power consumption is predicted at said judging step; and
receiving said increase prediction information output at said outputting step at said power supply unit and increasing a power supply capability before said timing.

16. A recording medium storing a power supply program in a circuit system having a circuit unit for performing a circuit operation by receiving a supply of power and a power supply unit for supplying power to the circuit unit, said program comprising commands for making a computer execute:
a first routine for judging whether or not an increase of the power consumption in said circuit unit after a certain timing is predicted;
a second routine of outputting increase prediction information of the supplied power to said circuit unit preceding the predicted timing when an increase of the power consumption is predicted in said first routine; and
a third routine of receiving said increase prediction information output in said second routine at said power supply unit and increasing the power supply capability before said timing.
